(19) United States
(12) Patent Application Publication
(10) Pub. No.: US 2008/0081322 A1
(43) Pub. Date: Apr. 3, 2008

(54) Teaching method for health assessment

(76) Inventor: Susan Anne Fosbrook, Davidsonville, MD (US)

Correspondence Address: SUSAN ANNE FOSBROOK, 3523 HUNTLEY DRIVE, DAVIDSONVILLE, MD, 21035, US

(21) Appl. No.: 11/906,031

(22) Filed: Sep. 28, 2007

Related U.S. Application Data
(60) Provisional application No. 60/848,518, filed on Sep. 29, 2006.

(51) Int. Cl. G09B 23/28

(52) U.S. Cl. 434/262

(57) ABSTRACT

This present invention comprises a training method for teaching health assessment of sick patients to health care providers. This training method utilizes a graphic display medium on printed charts, or in the case of computer software, three components: sequential assessment steps of the patient and care environment; color coded visual images representing bodily conditions; assessment questions of primary health complaints. The health care provider, by taking a mental snapshot, is equipped to make a systematic and focused health assessment of the patient and care environment that becomes a pattern of behavior each time the health care provider walks into the sick patient's room.

### CROSS-REFERENCE TO RELATED APPLICATIONS

This application claims benefit to provisional application of No. 60/848,518 and file date Sep. 29, 2006 and title Teaching Method for Health Assessment.

### FIELD OF INVENTION

The present invention relates to the graphic display medium and method of teaching health assessment of the patient and care environment to health care providers.

### BACKGROUND OF INVENTION

People are living longer today with the average life expectancy of 77.8 years. Over the last 30 years, there has been an increase in the number of hospitalizations in the elderly greater than 65 years of age. The number of long term care facilities, beds and home care services are on the rise. The uninsured, Medicare, Medicaid and managed care payment plans are changing the way people access health care and admit into hospitals. Outpatient departments, emergency rooms and physician offices are carrying an excess of one billion patient visits per year according to the Centers for Disease Control and Prevention statistics. Hospitals now have a reduced number of health care facilities, beds, lengths of stays and numbers of inpatient surgeries for patients.

Patients may arrive to emergency rooms and acute care hospitals presenting with severe illness, carry multiple complaints, co-morbidities and can have up to 10 or greater medical diagnoses. Acute care hospitals now have become intensive care units for the critically ill patients who require immediate assessment, diagnosis and intervention. Numerous diagnostic testing/screening, invasive procedures, advanced monitoring and medications have become the mainstay for the hospitalized patient.

Health care providers need to be attentive, develop keen assessment skills and provide expert medical and nursing interventions to achieve positive health outcomes with their patients. Sharper tools are necessary to evaluate ill patients more rapidly and assessments must be compared to earlier ones for recognition of improving or declining status. A sensory scan, awareness and understanding of the patient and care environment are necessary when patients present with multiple health care complaints, invasive lines, tubings and complex body system malfunctions.

### DESCRIPTION OF RELATED ART

Attempts of prior art have been made to better understand the human body, which include a stuffed teddy bear with a heart that is inserted which can be found in U.S. Pat. No. 5,044,959 and a therapeutic doll figure in U.S. Pat. No. 4,710,145 that can be held by children to better understand the human body and assist with impending surgery and upcoming medical treatments. Still anatomical charts with graphic body parts such as the bones or muscles can be used as reference devices. Medical charts have been provided with pictures and text of body systems with associated disease functions for heart disease and diabetes. Asthma cards in U.S. Pat. No. 5,984,685 help prepare patients to be alert for signs and symptoms of disease, when to take treatment and call physician. A skin lesion wheel in U.S. Pat. No. 5,727,949 can be held in the hand to assist patients with changes in skin characteristics such as shape, color and size to detect skin cancer early.

Additional prior art includes algorhythms for learning and performing basic life support, advanced cardiac life support and trauma resuscitation with patients which can be found in various books, videos, DVD's, laminated cards and laboratory hands-on preparation. Simulation training with a real life manikin and computerized technology with patient case scenarios as found in U.S. Pat. No. 6,638,073 assist health care providers in emergency aide techniques for a person with an injury. A documentation and assessment tool of various body systems with corresponding diagnostic labels and health information is found in U.S. Pat. No. 4,865,549 and a pre-printed chart and programmed screen display communicates pain location and intensity of a patient condition found in U.S. Pat. Nos. 5,984,368 and 5,720,502. Computerized documentation systems such as EmStat provide triage and body system assessment with multiple drop-down prompts for computing health assessments of the patients made at the bedside by health care providers.

Quick recall acronyms are used at bedside such as FLACC for assessment of the face, legs, activity, cry and consolability help to determine pain assessment and TICLS (Tickles) which includes tone, interactive, consolability, look, speech/cry are used for basic assessment of infants and children. Additionally, a mnemonic: ABC, in and out, PS is used to assist with assessment at bedside which stand for Airway, Breathing, Circulation, following tubes in and out and pain and safety.

The present inventor of this patent has made an improvement for teaching of health care providers and developed a method for health assessment with a sequential series of assessment steps correlating to visual graphics of the patient and care environment with focused questions to use when interacting with patient to identify the primary health complaint and plan of care. Also, the addition of the posture assessment with plurality of assessments steps provides valuable data about the body language and body condition of the patient when compared to the mnemonic: ABC, in and out, PS. The inventor has expanded the medium for display of the health assessment method on pre-printed cards to include the application of a decision making process in computer programming.

Nurses stand on the frontline as primary health care providers when patients are sick in the home and arrive to the doctor's office, outpatient departments, emergency rooms, trauma resuscitation rooms, battlefields, surgical suites, hospitals, transitional care/rehabilitation units and long term care health facilities. The nurse sees the patient first, places hands on the patient and may stay with the patient at the bedside throughout the entire course of their stay. Assessment is critical to the identification of the health problem, diagnosis, planning and implementation of the care and evaluation of the patient outcomes.

### SUMMARY

It is an object of the invention to provide a simple and efficient teaching method for health assessment of the patient and care environment for health care providers.

Another object of the invention is to reduce fear and anxiety of the health care provider when arriving at the patient's door, saying hello, and touching the medically ill patient.

And still another object of the invention is to provide an easy and ready-made assessment tool to assist health care providers to organize, collect and process health information safely at bedside.

And still another object of the invention is to process important health information of the patient and care environment through sensory and memory functioning.

And still another object of the invention is to assist health care providers to better understand how the human body works when patients become ill.

And still another object of the invention is to train health care providers how to obtain, recall, store and recall memory data of health information about the patient and care environment.

And still another object of the invention is to confirm and compare data against chart, diagnostics and health care team input for ready retrieval and response.

And still another object of the invention is to provide a novel and useful approach for health assessment of the patient and care environment that is inexpensive to manufacture and be used by various health care providers.

And still another object of the invention is to make priority health assessments and assist in the building of the complete medical picture safely at bedside.

### BRIEF DESCRIPTION OF THE DRAWINGS

FIG. 1 illustrates a blown-up embodiment of the patient exhibiting health complaints with bodily functions located on the right side of the visual display and associated steps for health assessment to be performed by the health care provider on the left side of the display.

FIG. 1, Step 1 illustrates the first health assessment which is the face of the patient who exhibits distress and pain with angled eyebrows and a downward rotation of the eyes and mouth.

FIG. 1, Step 2 illustrates the posture or body language of the patient which shows the patient grabbing at his chest with his right hand and arm to indicate chest discomfort.

FIG. 1, Step 3 illustrates tubes flowing into the patient such as intravenous fluids (IVF's) necessary for hydration post-operatively and inserted into left arm.

FIG. 1, Step 4 illustrates drains flowing out of the patient such as yellow urine draining into a foley bag to indicate kidney function. Also, the patient has a surgical dressing on his right knee that is dry and intact from a knee replacement surgery.

FIG. 1, Step 5 illustrates the care environment consisting of what is attached, connected to and surrounding the patient like the IV bag with approximately 850 cc of fluid left in bag (LIB), and the foley bag with approximately 280 cc of urine. Also the machines and equipment are noted in the care environment such as the oxygen flow meter that is attached to the wall.

FIG. 2 illustrates three assessment questions as the nursing student is interacting with the patient to collect data of the primary health complaint(s) of the day and make a plan of care.

FIG. 2, Step 1 illustrates listening to the patient's story and medical and surgical history to find out what brought the patient to the hospital or health care facility. Reflecting on specific patient signs and symptoms helps identify the health problem(s).

FIG. 2, Step 2 illustrates focusing on the patient's primary complaint(s) of the day to locate the body part(s) in distress. This focus of assessment is the pathology piece that guides the health care provider in finding which system(s) are functioning abnormally.

FIG. 2, Step 3 illustrates determining the Medical-Surgical goal(s) for the patient and recognizing the need for providing prompt medical and nursing interventions. Making and implementing an appropriate plan of care will improve the health status of the patient.

### DETAILED DESCRIPTION OF INVENTION

### What is the Invention?

Beginning nursing students can be frightened and overwhelmed by the multiple stimuli in the patient's room. Nursing students need training on knowing how to perceive and process important health information efficiently. My invention is an assessment method for teaching nursing students to walk into a patient's room and take a mental snapshot after saying hello. This training method utilizes three components: sequential assessment steps of the patient and care environment; color coded visual images representing bodily conditions; assessment questions of primary health complaints. These components can be created as graphic display mediums on printed charts or on interactive computer modules.

This teaching method for health assessment employs an information processing model of memory and sensory function that guides the student nurse to mentally collect significant patient data at the bedside. As the student nurse encounters the patient and care environment, the student creates a mental representation of the perceptual field. Attention is focused on specific mental snapshots or mental images in the clinical environment such as the patient's face, the posture, the tubes infusing into the patient, the drains flowing out of the patient and the care environment. It is the care environment which includes machines and equipment connected to, attached and surrounding the patient. Processed information is transformed, encoded and stored in the short-term and long-term memory. These mental snapshots can be retrieved for further exploration, comparison and discussion to enhance learning and understanding of the complete clinical picture of the patient's presentation.

### How to Use the Invention.

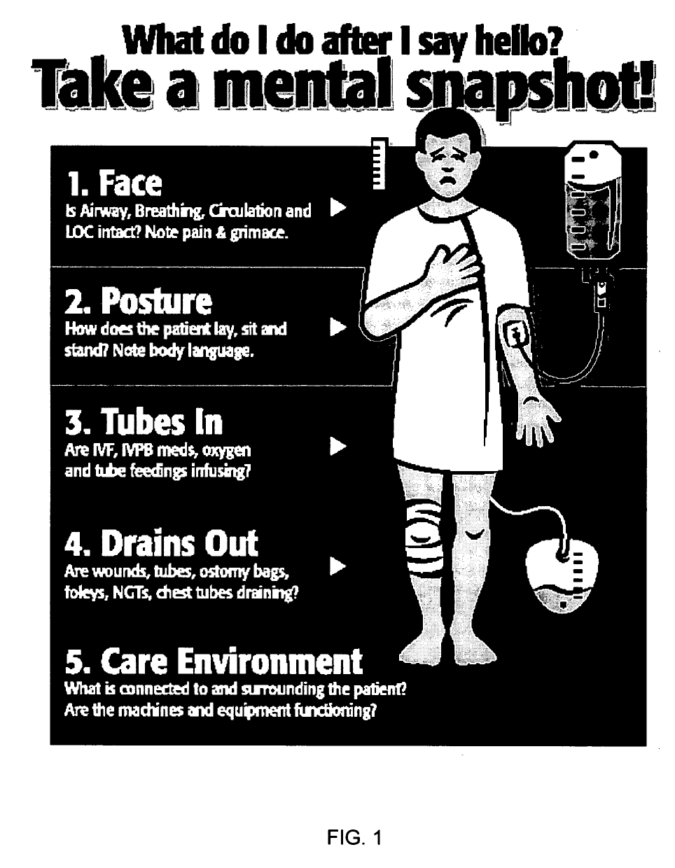

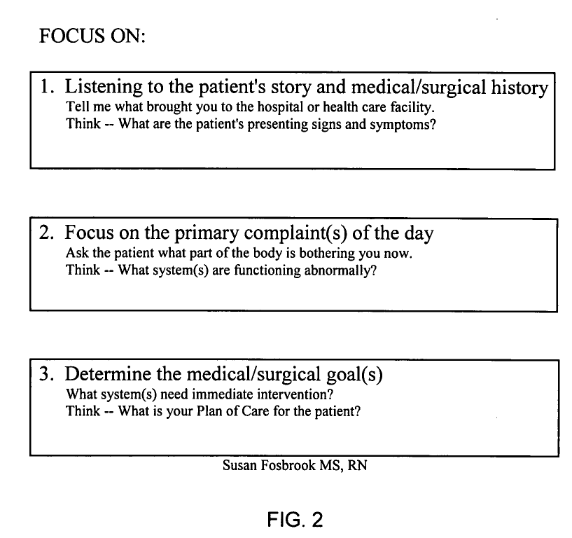

The visual display in FIG. 1 provides assessment of a medical-surgical patient who has undergone a right knee replacement surgery and now presents with a new onset of chest pain and shortness of breath. Detailed assessment steps are presented on the left side of the graphic. A figure of the patient in pain is on the right side of the graphic. Both can function together or independently when assessing the patient and care environment. FIG. 2 provides additional assessment questions for the nursing students to focus on and use when interacting with the patient to identify the primary health complaint(s) and make an appropriate plan of action.

The visual aid in FIG. 1 can be a laminated pocket card used as a cue or prompt while held in the palm of the student's hand. The nursing student uses mental snapshot assessments to critically look at the patient and the care environment. On the backside of FIG. 1, is FIG. 2 which provides additional assessment questions for prioritizing health data while interacting with the patient.

As noted on the right side of FIG. 1, Step 1, the face is chosen as the first focus of attention. The assessment of the mouth serves as the critical indicator to monitor patient Airway for patency, ease of Breathing and observing color for Circulation. Airway, Breathing, and Circulation (ABC's) are the most important health assessments that can be made by the nurse at the bedside. Talking with the patient can show orientation to person, place and time and indicate level of consciousness. The facial expressions of the patient as noted on the right side of the graphic figure shows angled eyebrows, downward deflection of the eyes and mouth, signaling pain and grimace requiring prompt attention.

In FIG. 1, Step 2, the student nurse assesses posture which examines the patient's body position and language. The patient is found grabbing his chest with his right hand to signal chest discomfort. This is a significant finding for a surgical patient with a total replacement of the right knee and requires prompt intervention.

In FIG. 1, Step 3, the student nurse assesses the IVF's infusing into the patient. The student takes a gloved hand and follows the tubing from the insertion site of the IV catheter to the pump, determining the flow rate and volume to be infused, all the way to the IVF bag with approximately 850 cc of fluid remaining.

In FIG. 1, Step 4, the student assesses drains coming out of the patient such as approximately 280 cc of yellow urine draining into the foley bag which is checked for color, amount and concentration. The post op dressing on the right knee is found to be dry and intact.

In FIG. 1, Step 5, the student assesses the care environment which includes what is attached, connected to, or surrounding the patient. This includes the IVF bags with approximately 850 cc of fluid LIB and a foley bag with approximately 280 cc of yellow urine with tubings attached or connected to the patient. Machines and equipment surrounding the patient, such as the oxygen flow meter found on the wall, is turned off with no attachment of oxygen tubing to the patient. This may indicate concern when a patient presents with chest pain and is short of breath.

In FIG. 2 the nursing student turns the pocket card over and focuses on three additional assessment steps when interacting with the patient.

In FIG. 2, Step 1, the student asks the patient what brought him to the hospital and obtains more health history. The patient reports he has arthritis in his right knee and came to the hospital for right knee replacement surgery. He complains of daily bouts of right knee pain uncontrolled by medicine and the knee keeps buckling when he walks. Prior to surgery no heart disease history was reported.

In FIG. 2, Step 2, the student asks the patient what body part is bothering him today. The patient grabs at his chest and reports he has a sharp stabbing pain with shortness of breath. Two systems of concern are the heart for possible angina or a heart attack and the lungs for possible blood clot from knee replacement surgery.

In FIG. 2, Step 3, the student nurse alerts the primary nurse and instructor of the new complaint of chest pain and together they set appropriate medical-surgical goals for the patient. To reduce work load to the heart and lungs the patient is returned to bed and advised to rest. The head of the bed is elevated and vital signs are taken. The doctor is notified of the variance (change in health status) and the hospital chest pain protocol is implemented.

### How to Produce the Invention

Through the use of professional computer graphics, pocket size cards can be created for nursing students to carry as they walk into the patient's room. In addition, the invention can take the form of flip chart notebooks to sit on a tabletop, lab wall posters, flash cards, conference size posters, video presentations and computer interactive modules. For longevity these visual aids can be laminated or produced on durable materials.

### Who would Use the Invention?

This method was originally designed for training nursing students. The use and effectiveness of this method however, can be expanded to include all disciplines of health care providers.

### Advantages of the Invention

This method is a handy, efficient and affordable assessment tool for multiple health care providers. It allows nursing students to enter the patient's room with less fear and anxiety and learn how to prioritize health assessments. It provides a means to organize, collect and process data safely at the bedside. This versatile tool can be used in all fields of health care at various levels of education. It enables students to use sensory and memory skills to build a complete clinical picture of the patient.

It should be understood that various changes may be made to the teaching method of health assessment and preferred embodiments as described in detail herein without departing from the spirit and scope of the invention as defined in the following claims.

What is claimed is:

1. A training method for teaching health assessment comprising:
a) a color coded graphic display medium including:
i) a plurality of assessment steps of the patient and care environment
ii) a plurality of visual images representing bodily conditions
iii) a plurality of assessment questions of primary health complaint(s).
Whereby the health care provider can make a systematic and focused health assessment of the patient and care environment that becomes a pattern of behavior each time the health care provider walks into the patient's room.

2. A training method for health assessment as in claim 1, wherein said plurality of assessment steps includes patients of disciplines of healthcare such as, but not limited to:
a) medical surgical
b) intensive care
c) pediatric
d) obstetrics
e) psychiatric
f) community health
g) geriatric
h) rehabilitation

3. A training method for health assessment as in claim 1, wherein said plurality of visual images includes patients of different:
a) sexes
b) ages
c) nationalities
d) cultures
e) languages

4. A training method for health assessment as in claim 1, wherein said plurality of visual images representing various portions of the human body and bodily conditions.

5. A training method for teaching health assessment comprising of:
a) a computer control unit
b) a plurality of assessment steps of the patient and care environment
c) a plurality of visual images
d) a plurality of assessment questions for primary health complaint(s)
Whereby the health care provider can interact with the computer program to facilitate the decision-making process in determining the bodily condition(s) of the patient and care environment.

6. A training method for health assessment as in claim 5, wherein said computer unit includes database driven matrixes.
